(19) United States
(12) Patent Application Publication
(10) Pub. No.: US 2026/0161043 A1
(43) Pub. Date: Jun. 11, 2026

(54) NON-COLLINEAR SUM-FREQUENCY GENERATION

(71) Applicant: Coherent LaserSystems GmbH & Co. KG, Göttingen (DE)

(72) Inventor: Christian HAGEMANN, Pogeez (DE)

(73) Assignee: Coherent LaserSystems GmbH & Co. KG, Göttingen (DE)

(21) Appl. No.: 18/977,650

(22) Filed: Dec. 11, 2024

(51) Int. Cl. G02F 1/35; G02F 1/355

(52) U.S. Cl. CPC G02F 1/3509; G02F 1/3503; G02F 1/3534; G02F 1/3551; G02F 2201/17; G02F 2203/15

(57) ABSTRACT

A device for non-collinear sum-frequency generation includes a nonlinear crystal having two non-parallel input faces, two non-parallel output faces, and a third output face that is non-parallel to the first two output faces. Normal vectors of the two input faces point away from the crystal in diverging directions. Normal vectors of the first two output faces point away from the crystal in diverging directions. In operation, a non-collinear relationship between two input beams, facilitated by the crystal shape, advantageously separates the frequency-converted output laser beam from the input beams. A laser apparatus for non-collinear second-harmonic generation includes a ring resonator to resonantly enhance an initial laser beam and direct the initial beam along a path including non-collinearly first and second segments intersecting in a nonlinear crystal. The non-collinear relationship between the two passes of the initial beam advantageously separates a second-harmonic beam, generated in the crystal, from the initial beam.

### TECHNICAL FIELD

The present invention relates in general to sum-frequency mixing of non-collinear laser beams in an optically-nonlinear crystal. The present invention relates in particular to crystal-shapes and resonant-enhancement cavities that are well-suited for second-harmonic generation, or more general sum-frequency generation, to produce deep-ultraviolet laser light with relatively high average-power.

### DISCUSSION OF BACKGROUND ART

Deep-ultraviolet (DUV) laser sources are of importance in a variety of industrial and scientific applications, including precise machining, photolithography, semiconductor inspection, materials analysis, and photoemission spectroscopy. The DUV wavelength range spans from 300 nanometers (nm) down to 100 nm. In machining, photolithography, and semiconductor inspection, the short wavelength of DUV laser radiation enables the formation or detection of features smaller than those achievable or detectable with longer-wavelength ultraviolet laser radiation or visible laser radiation.

Several different approaches have been used to generate DUV laser radiation. Excimer lasers in particular have been widely used for DUV generation, especially in semiconductor photolithography. Excimer lasers have a gaseous gain medium and generate ultraviolet nanosecond laser pulses. Unfortunately, excimer lasers are limited to pulsed operation and therefore do not work for applications that require continuous-wave (cw) laser beams. Such applications include certain forms of semiconductor inspection, photolithography, writing of Fiber Bragg gratings, and spectroscopy.

Solid-state lasers, based on a solid-state gain medium in the form of a crystal or a glass, present an attractive solution for generating cw DUV laser light. Solid-state lasers are also an alternative to excimer lasers for generating pulsed DUV laser light with many compelling advantages. Solid-state lasers are relatively small and affordable, have efficient lasing action, generate laser beams with excellent beam quality, have a low cost of operation, and, unlike excimer lasers, do not involve corrosive or toxic gases. Typically, the solid-state laser gain medium is a glass or crystal doped with rare-earth ions, such as neodymium, erbium, or ytterbium. When energized in a laser resonator or amplifier, the rare-earth ions generate near-infrared laser radiation. So far, no diode-pumped or flash-lamp-pumped solid-state laser is capable of directly generating DUV laser radiation. Instead, frequency conversion in optically-nonlinear media is used to reach DUV wavelengths.

Nonlinear crystals are employed to convert the output beam of a solid-state laser to a shorter wavelength. Herein, a “nonlinear crystal” refers to a crystal that exhibits optical nonlinearity. Through multiple stages of frequency conversion in nonlinear crystals, DUV laser radiation can be generated from the output of a near-infrared solid-state laser. For example, a solid-state laser with a neodymium-doped gain crystal can generate a 1064 nm laser beam, which can then be used to generate a 266 nm laser beam through two sequential stages of second-harmonic generation.

Efficient sum-frequency mixing (e.g., second-harmonic generation) in a nonlinear crystal relies on the input laser beam, or beams, being phase matched with the frequency-converted output laser beam. When such phase matching exists, frequency-converted laser radiation generated at each spatial location interferes constructively with frequency-converted laser radiation generated at preceding spatial locations as the laser beams propagate through the nonlinear crystal. This is nontrivial since the refractive index of the nonlinear crystal varies with wavelength and temperature, and at least two different wavelengths are involved in the sum-frequency generation processes.

Critical phase matching, also known as “angle phase matching”, is the preferred phase matching technique in many scenarios and sometimes the only viable phase matching technique. Critical phase matching utilizes a birefringent nonlinear crystal and takes advantage of the polarization dependence of the refractive index of this birefringent nonlinear crystal. Critical phase matching is generally performed with linearly polarized beams and is most easily understood within the context of uniaxial birefringent crystals. A uniaxial crystal has an optic axis and is characterized by ordinary and extraordinary refractive indices. For any given laser beam, the optic axis of the uniaxial crystal and the wave vector of the laser beam together define a principal plane. A beam is termed an “ordinary” beam when its polarization is normal to the principal plane and an “extraordinary” beam when its polarization is parallel to the principal plane. An ordinary beam always experiences the ordinary refractive index. An extraordinary beam, on the other hand, experiences a refractive index in the range between the ordinary and extraordinary refractive indices, with the value of the refractive index depending on the angle between the wave vector and the optic axis. Sum-frequency generation with critical phase matching involves both ordinary and extraordinary beams. For suitable combinations of crystal material and temperature, and wavelengths and polarization directions of the input beams, phase matching is achieved at a particular orientation of the optic axis of the nonlinear crystal relative to the wave vectors of the input beams.

Second-harmonic generation can be, and typically is, performed with a single input beam. For sum-frequency generation involving two input beams of different wavelengths, critical phase matching is most often performed with collinear input beams. However, one or two of the interacting laser beams are subject to walk-off, in which the Poynting vector of each such beam is at a non-zero angle to the wave vector of the beam. In uniaxial crystals, extraordinary beams are subject to walk-off, and the walk-off angle depends on the difference between the ordinary and extraordinary refractive indices as well as the angle between the wave vector and the optic axis. Despite walk-off, the longest interaction length between the involved laser beams is typically achieved with collinear phase-matching.

Sum-frequency generation in the cw regime is often aided by resonant enhancement of the input laser beam(s). Unlike sum-frequency generation based on pulsed laser beams, the cw frequency-conversion process does not benefit from high peak powers. The cw conversion efficiency may therefore be relatively low. Resonant enhancement of an input beam can significantly improve the conversion efficiency. For example, the efficiency of cw second-harmonic generation can be improved by injecting the input laser beam into a resonant-enhancement cavity that contains the nonlinear crystal. FIG. 1 shows one such prior-art laser apparatus 100. In prior-art apparatus 100, an input beam 180 from a laser 150 is injected into a resonant-enhancement cavity 120, a so-called “bowtie cavity”, defined by cavity-mirrors 122. Nonlinear crystal 110 is located in cavity 120 and partially converts input beam 180 into a second-harmonic beam 184. The power of input beam 180 circulating in resonant-enhancement cavity 120 may be much greater than the power directly emitted by laser 150. Since the second-harmonic generation efficiency scales with the square of the fundamental input power, the resonant enhancement of input beam 180 may result in second-harmonic beam 184 having orders-of-magnitude greater power than would be achievable without resonant enhancement. Other than a small lateral displacement caused by walk-off, second-harmonic beam 184 and input beam 180 co-propagate after exiting nonlinear crystal 110, until reaching a dichroic mirror 130 that extracts second-harmonic beam 184 from the path of input beam 180.

### SUMMARY

Disclosed herein are nonlinear crystals and resonant-enhancement cavities for sum-frequency mixing of two non-collinear input laser beams. The non-collinear relationship between the input beams produces angular and lateral separation of the frequency-converted output laser beam from the input beams. We have recognized that such separation is advantageous, especially when the frequency-converted output beam is in the DUV spectral range and the objective is to generate a relatively high average-power of, e.g., several watts or more.

In sum-frequency generation schemes where the frequency-converted output beam and the input beam(s) are not separated from each other, undesirable non-degenerate two-photon absorption may take place. Such non-degenerate two-photon absorption involves a photon from the frequency-converted output beam and a photon from the input beam(s). Especially when the frequency-converted output beam is in the DUV spectral range, materials intersected by the overlapping beams may be degraded by non-degenerate two-photon absorption. The most vulnerable materials are surface coatings. For example, in the prior-art apparatus of FIG. 1, the power of second-harmonic beam 184 may be limited by the damage threshold imposed by non-degenerate two-photon absorption in either one of (a) a coating on the exit face of nonlinear crystal 110 and (b) a dichroic coating on dichroic mirror 130.

The non-collinear approach disclosed herein may eliminate the need for a dichroic beamsplitter element, since the frequency-converted output beam propagates away from the nonlinear crystal in a different direction than the input beams. Additionally, the nonlinear crystal itself may be sufficiently long that the frequency-converted output beam is separated from the input beams before exiting the nonlinear crystal, thereby preventing damage to any coating on the exit face(s) of the nonlinear crystal from non-degenerate two-photon absorption involving photons from the frequency-converted output beam. This non-collinear approach is therefore feasible at relatively high average-powers in the DUV spectral range.

The present non-collinear approach may utilize resonant enhancement to increase the average power of the input beams at the nonlinear crystal, which is particularly advantageous for cw beams. In certain embodiments disclosed herein, the nonlinear crystals are shaped and/or arranged such that both input laser beams are incident on and exit the nonlinear crystal at or near Brewster's angle, thereby reducing Fresnel reflection losses. In some embodiments, the disclosed nonlinear crystal has an unconventional shape tailored to receive two input beams propagating with a large angle therebetween while also allowing for each of the two input beams to be incident on and exit the nonlinear crystal at Brewster's angle. This unconventional shape is particularly well-suited for implementation in a bowtie resonant-enhancement cavity.

In one aspect of the invention, a device for non-collinear sum-frequency generation includes an optically-nonlinear crystal having an input end and an output end. The input end includes first and second input faces that are planar and mutually non-parallel. The output end is opposite the input end and includes (a) first and second output faces that are planar and mutually non-parallel and (b) a third output face that is non-parallel to each of the first and second output faces. Respective normal vectors of the first and second input faces point away from the crystal in mutually-diverging directions, and respective normal vectors of the first and second output faces point away from the crystal in mutually-diverging directions.

In another aspect of the invention, a laser apparatus for resonantly enhanced non-collinear second-harmonic generation includes a laser source to generate an initial laser beam, and a resonant-enhancement cavity containing an optically-nonlinear crystal and arranged to receive the initial laser beam so as to resonantly enhance the initial laser beam. The resonant-enhancement cavity is a ring resonator configured to direct the initial laser beam along a closed path including non-collinearly intersecting first and second segments intersecting in the crystal, so as to generate a second-harmonic laser beam from non-collinear sum-frequency mixing of (a) a first input laser beam formed by the initial laser beam when passing through the crystal along the first segment and (b) a second input laser beam formed by the initial laser beam when passing through the crystal along the second segment.

### BRIEF DESCRIPTION OF THE DRAWINGS

The accompanying drawings, which are incorporated in and constitute a part of the specification, schematically illustrate preferred embodiments of the present invention, and together with the general description given above and the detailed description of the preferred embodiments given below, serve to explain principles of the present invention.

FIG. 1 shows a prior-art laser apparatus for resonantly enhanced second-harmonic generation in a nonlinear crystal located in a bowtie cavity.

FIGS. 2A and 2B illustrate a device for non-collinear sum-frequency generation in a nonlinear crystal, according to an embodiment. This device includes a nonlinear crystal shaped to enable separation of the frequency-converted output beam from the input beams in non-collinear sum-frequency generation.

FIG. 3A-C illustrate exemplary laser beam propagation through an embodiment of the device of FIGS. 2A and 2B that utilizes a uniaxial birefringent nonlinear crystal.

FIG. 4 illustrates a laser apparatus for resonantly-enhanced, non-collinearly phase-matched second-harmonic generation in the device of FIGS. 2A and 2B, which utilizes a single resonant-enhancement cavity to produce two non-collinear input beams for the second-harmonic generation process, according to an embodiment.

FIG. 5 illustrates a laser apparatus for resonantly-enhanced, non-collinearly phase-matched sum-frequency generation in the device of FIGS. 2A and 2B, which utilizes two resonant-enhancement cavities, according to an embodiment.

FIG. 6A-C illustrate another nonlinear crystal that enables separation of the frequency-converted output beam from the input beams in non-collinear sum-frequency generation, according to an embodiment.

FIGS. 7A and 7B illustrate a nonlinear crystal that is closer to cuboidal in shape and enables separation of the frequency-converted output beam from the input beams in non-collinear sum-frequency generation, according to an embodiment.

FIGS. 8A and 8B illustrate a nonlinear crystal that is shaped as a right parallelogrammic prism and enables separation of the frequency-converted output beam from the input beams in non-collinear sum-frequency generation, according to an embodiment.

### DETAILED DESCRIPTION

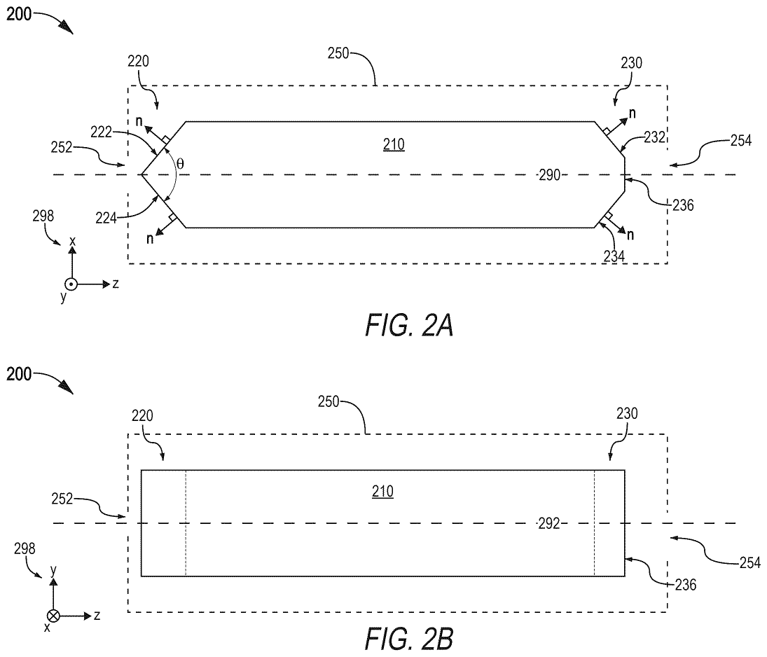

Referring now to the drawings, wherein like components are designated by like numerals, FIGS. 2A and 2B are orthogonal cross-sectional views of one device 200 for non-collinear sum-frequency generation in a nonlinear crystal. The cross sections depicted in FIGS. 2A and 2B are in the xz-and yz-planes, respectively, of a cartesian coordinate system 298. Hereinafter, reference to x-, y-, and z-dimensions, axes, and associated planes refers to coordinate system 298. Device 200 includes a nonlinear crystal 210 and, optionally, an oven 250 that heats crystal 210 to a temperature exceeding the ambient temperature.

Nonlinear crystal 210 has an input end 220 and an output end 230. Input end 220 includes planar input faces 222 and 224 that are non-parallel to each other. Input faces 222 and 224 are oriented such that respective normal vectors thereto point away from crystal 210 in diverging directions. This corresponds to the internal angle θ between input faces 222 and 224 being less than 180 degrees. Output end 230 includes planar output faces 232, 234, and 236, none of which are parallel to each other. Output faces 232 and 234 are also oriented such that respective normal vectors thereto point away from crystal 210 in diverging directions. In certain embodiments, output face 232 is parallel to input face 224, and output face 234 is parallel to input face 222.

Input faces 222 and 224, and output faces 232, 234, and 236 may be orthogonal to and intersect a common plane 292 that is parallel to the xz-plane. Input faces 222 and 224 may be positioned on opposite sides of a plane 290 that is orthogonal to plane 292 and intersects input end 220 and output end 230. Plane 290 is parallel to the yz-plane. Similarly, output faces 232 and 234 may be on opposite sides of plane 290. Output face 236 may be positioned between output faces 232 and 234. Crystal 210 may be symmetric with respect to reflection in plane 290.

Crystal 210 may be birefringent, such that sum-frequency generation in crystal 210 can benefit from critical phase matching. In one embodiment, crystal 210 is a uniaxial crystal, for example made of beta barium borate (BBO), ammonium dihydrogen phosphate (ADP), potassium dihydrogen phosphate (KDP), or cesium lithium borate (CLBO). In another embodiment, crystal 210 is a biaxial crystal, for example made of lithium triborate (LBO) or cesium borate (CBO).

Oven 250, if included, may include a housing that contains crystal 210 but has openings 252 and 254 allowing for laser beams to pass through crystal 210.

As is discussed in further detail below, the shape of crystal 210, when applied to non-collinear sum-frequency generation, enables separation of the frequency-converted output beam from the input beams. Herein, two laser beams are considered separate from each other when their respective 1/e² transverse intensity profiles are non-overlapping. The shape of crystal 210 also allows for the input beams to be incident on both input and output faces of crystal 210 at Brewster's angle, thereby minimizing Fresnel reflection losses for the input beams.

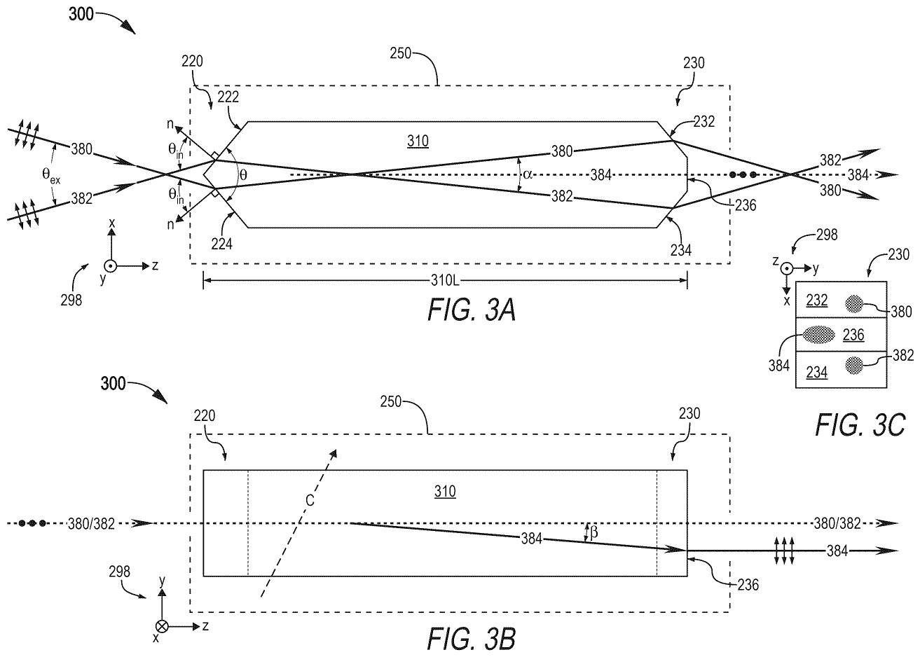

FIG. 3A-C illustrate exemplary laser beam propagation through one device 300 for non-collinear sum-frequency generation that utilizes a uniaxial nonlinear crystal. Device 300 is an embodiment of device 200, wherein crystal 210 is implemented as a uniaxial birefringent crystal 310 oriented with its optic axis “C” parallel to the yz-plane. FIGS. 3A and 3B show device 300 in the same cross-sectional views as used for device 200 in FIGS. 2A and 2B, respectively. FIG. 3C depicts output end 230 of crystal 310 as viewed from outside crystal 310.

As shown in FIG. 3A, two input laser beams 380 and 382 propagate in the xz-plane. Input beams 380 and 382 propagate toward input end 220 with a non-zero angle θₑₓ between their respective propagation directions. Input beams 380 and 382 cross each other before reaching input end 220. Input beam 380 is incident on input face 224, and input beam 382 is incident on input face 222. In the depicted example, input beams 380 and 382 are incident on respective input faces 224 and 222 at the same angle of incidence θᵢₙ. After refraction at input faces 222 and 224, input beams 380 and 382 intersect inside crystal 310 with a non-zero angle α between their respective propagation directions. Angle α may be in the range between 5 and 50 milliradians. Input beams 380 and 382 exit crystal 310 via output faces 232 and 234, respectively. Input beams 380 and 382 cross each other again after leaving crystal 310, whereafter their respective propagation directions diverge from each other. When output faces 232 and 234 are parallel to input faces 224 and 222, respectively, input beams 380 and 382 propagate at angle θₑₓ between their respective propagation directions after leaving crystal 310.

Sum-frequency mixing of input beams 380 and 382 in crystal 310 produces a frequency-converted laser beam 384 that leaves crystal 310 via output face 236. Frequency-converted beam 384 may have a DUV wavelength, for example in the range between 200 and 300 nm, and its average power may be one watt or more, for example between 1 and 20 watts. Beams 380, 382, and 384 may be pulsed or cw beams.

In the depicted embodiment, the sum-frequency mixing process utilizes non-collinear critical phase matching. In this embodiment, input beams 380 and 382 are ordinary beams with their polarizations parallel to the xz-plane, and frequency-converted beam 384 is an extraordinary beam with its polarization parallel to the yz-plane. Frequency-converted beam 384 is subject to walk-off away from the propagation plane of input beams 380 and 382, as shown in FIG. 3B. Frequency-converted beam 384 propagates parallel to the yz-plane. The propagation path of frequency-converted beam 384 inside crystal 310 is at a walk-off angle β to the plane of propagation of input beams 380 and 382. After leaving crystal 310, frequency-converted beam 384 propagates parallel to the propagation plane of input beams 380 and 382 but offset from this propagation plane due to the walk-off. The projection of the propagation path of frequency-converted beam 384 onto the propagation plane of input beams 380 and 382 is indicated by a dashed line in FIG. 3A. Similarly, the projection of the propagation paths of input beams 380 and 382 onto the propagation plane of frequency-converted beam 384 are indicated in FIG. 3B by a dashed line.

The length 310L of crystal 310 is chosen such that input beams 380 and 382 and frequency-converted beam 384 are separate from each other at output end 230. This separation prevents potentially undesirable spatial overlap between frequency-converted beam 384 and input beams 380 and 382 at output end 230. Such spatial overlap could lead to non-degenerate two-photon absorption at the surface of crystal 210, especially if this surface is coated. To achieve this separation, length 310L may exceed 10 millimeters and for example be in the range between 10 and 100 millimeters (mm). As shown in FIG. 3C, beams 380, 382, and 384 leave crystal 310 via three different faces of output end 230. Furthermore, after the subsequent crossing of input beams 380 and 382, the non-collinear relationship between input beams 380 and 382 causes the separation between input beams 380 and 382 and frequency-converted beam 384 to grow (after input beams 380 and 382 have crossed each other on the output side of crystal 310). The three different propagation directions of input beams 380 and 382 and frequency-converted beam 384 naturally separates frequency-converted beam 384 from input beams 380 and 382, thereby eliminating the need for a dichroic optic to impose this separation.

In one implementation, input beams 380 and 382 are incident on the corresponding input faces 224 and 222 at Brewster's angle, and output faces 232 and 234 are parallel to input faces 224 and 222, respectively. In this implementation, input beams 380 and 382 are incident on the corresponding output faces 232 and 234 at the internal Brewster's angle. This implementation minimizes Fresnel losses for input beams 380 and 382. It is understood that alignment tolerances may cause some deviation from incidence exactly at Brewster's angle. For example, the angles of incidence of input beams 380 and 382 on respective input faces 224 and 222 may be within 4 degrees of Brewster's angle, preferably within 2 degrees of Brewster's angle, and more preferably within 1 degree of Brewster's angle.

Internal angle θ may be less than the sum of the two respective Brewster's angles for input beams 380 and 382, in order to allow the input beams 380 and 382 to be incident on input faces 224 and 222 while also ensuring that input beams 380 and 382 intersect in crystal 210. For example, when crystal 210 is made of CLBO and input beams 380 and 382 both have a wavelength of 532 nm, Brewster's angle for each input beam is 56.25 degrees. In this example, internal angle θ may be less than 112.5 degrees, for example in the range between 109.5 and 112.5 degrees.

Embodiments of crystal 210 where faces 222, 224, 232, 234, and 236 are orthogonal to a common plane advantageously allow for translation of crystal 210 orthogonally to this plane without disturbing the propagation paths through crystal 210 of input beams 380 and 382 and frequency-converted beam 384. Such translation may be useful in case of optical degradation of crystal 210.

Referring again to device 200, crystal 210 may have properties that differ from those of crystal 310, while still allowing for a beam propagation pattern similar to that depicted in FIG. 3A-C. For example, crystal 210 may be a uniaxial birefringent crystal with its optic axis oriented differently from that shown in FIG. 3B, crystal 210 may be a biaxial birefringent crystal, and/or the polarization directions of beams 380, 382, and 384 may be different from those depicted in FIGS. 3A and 3B. With such changes compared to crystal 310, different beams may be subject to walk-off. For example, input beams 380 and 382 may be extraordinary beams subject to walk-off while frequency-converted beam 384 is an ordinary beam. Also in these scenarios, the non-collinear relationship between input beams 380 and 382 will, together with the shape of crystal 210, separate frequency-converted beam 384 from input beams 380 and 382 in a manner similar to that shown in FIG. 3A-C. However, the depicted configuration, where input beams 380 and 382 are ordinary beams may simplify implementation in a laser apparatus, since input beams 380 and 382 are not subject to walk-off in this configuration and therefore may propagate in a common plane.

In one use scenario, input beams 380 and 382 are in the visible spectral range, and frequency-converted beam 384 is ultraviolet. For example, blue, cyan, or green input beams 380 and 382 may produce a DUV frequency-converted beam 384.

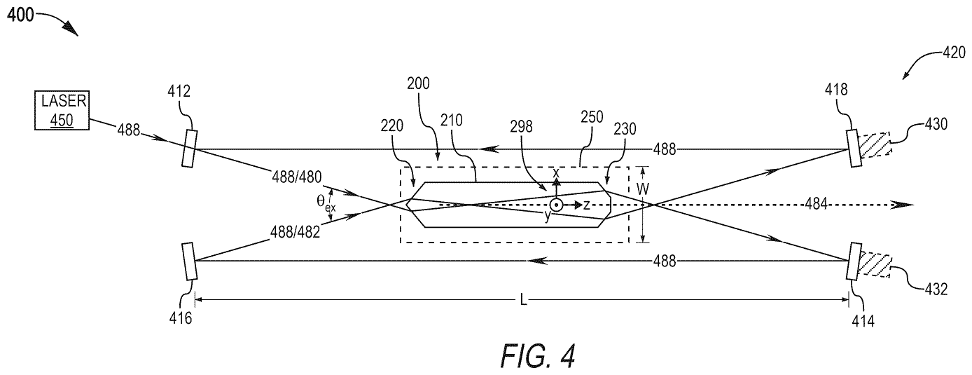

FIG. 4 illustrates one laser apparatus 400 for resonantly-enhanced, non-collinearly phase-matched second-harmonic generation in device 200, which utilizes a single resonant-enhancement cavity to produce two non-collinear input beams for the second-harmonic generation process. Laser apparatus 400 includes device 200, a resonant-enhancement cavity 420 and a laser 450. Laser 450 may be a solid-state laser. Cavity 420 is a ring resonator that contains crystal 210 and, optionally, oven 250. Laser 450 generates an initial laser beam 488 that is coupled into cavity 420. Beam 488 may be a cw beam. Cavity 420 resonantly enhances beam 488, such that the circulating laser power in cavity 420 exceeds the initial power of beam 488 generated by laser 450. Cavity 420 directs beam 488 along a closed path including two segments that intersect each other, non-collinearly, in crystal 210.

In the depicted embodiment, cavity 420 is a bowtie cavity defined by four reflectors 412, 414, 416, and 418, and the propagation path of initial laser beam 488 is in the xz-plane. Reflector 412 couples in beam 488. Other ring-resonator configurations are possible as well, provided that the propagation path includes two segments that cross each other. The following discussion of apparatus 400, pertaining to the bowtie configuration of cavity 420, can be readily generalized to other such ring-resonator configurations.

In crystal 210, the segment from reflector 412 to reflector 414 crosses the segment from reflector 416 to reflector 418. When beam 488 propagates along the segment from reflector 412 to reflector 414, beam 488 functions as one input beam 480 to non-collinear second-harmonic generation in crystal 210. Input beam 480 passes through input face 224 and output face 232 (see FIGS. 2A and 2B), and input beam 482 passes through input face 222 and output face 234. Input beam 480 may propagate through crystal 210 in a manner similar to input beam 380 of FIG. 3A-C. When beam 488 propagates along the segment from reflector 416 to reflector 418, beam 488 functions as another input beam 482 to non-collinear second-harmonic generation in crystal 210. Input beam 482 may propagate through crystal 210 in a manner similar to input beam 382 of FIG. 3A-C. Thus, by virtue of intersecting propagation-path segments, the single laser beam 488 circulating in cavity 420 provides two non-collinearly intersecting input beams 480 and 482 for second-harmonic generation in crystal 210. The resulting second-harmonic beam 484 leaves cavity 420 and may follow a path similar to that of frequency-converted beam 384 of FIG. 3A-C.

Cavity 420 may be configured such that beam 488 is incident on the input and output faces of crystal 210 at Brewster's angle, for each of the two propagation-path segments passing through crystal 210.

Advantageously, the non-parallel input faces and the non-parallel output faces of crystal 210 makes it possible to operate with a relatively large angle θₑₓ between input beams 480 and 482 outside crystal 210, while achieving a reasonably small angle α (see FIG. 3A) between input beams 480 and 482 inside crystal 210. A relatively small angle α provides for a relatively long interaction length in crystal 210, which aids efficient second-harmonic generation. A relatively large angle θₑₓ helps enable a compact configuration of cavity 420, while accommodating the width W of device 200 (which may include an oven 250). For any given width W of device 200, a larger angle θₑₓ between input beams 480 and 482 allows for a shorter length L of cavity 420.

In certain embodiments, the length of the closed propagation path of beam 488 in cavity 420 is adjustable so as to actively ensure resonant enhancement of beam 488. This may be achieved by mounting one of the reflectors, defining cavity 420, on an actuator such as a piezoelectric actuator. In the depicted example, reflector 418 is mounted on a piezoelectric actuator 430. In one such embodiment, one more reflector is mounted on an actuator to facilitate adjustment of the relative phase between input beams 480 and 482 in crystal 210. In the depicted example, reflector 414 is mounted on a piezoelectric actuator 432. The relative phase between input beams 480 and 482 determines an interference pattern between input beams 480 and 482 in crystal 210. The non-collinear relationship between input beams 480 and 482 adds complexity to this interference pattern. In particular, a phase difference of π between input beams 480 and 482 produces an interference pattern that minimizes the spatial overlap between the input beams and the frequency-converted beam inside crystal 210. Minimizing the spatial overlap between the input beams and the frequency-converted beam in this manner does not significantly impact the frequency-conversion efficiency but reduces the risk of potentially degrading non-degenerate two-photon absorption in the bulk of crystal 210. In one scenario, actuators 430 and 432 are operated such that (a) the total propagation length inside cavity 420 is selected to resonantly enhance input beams 480 and 482 and (b) there is a phase difference of π between input beams 480 and 482 inside crystal 210.

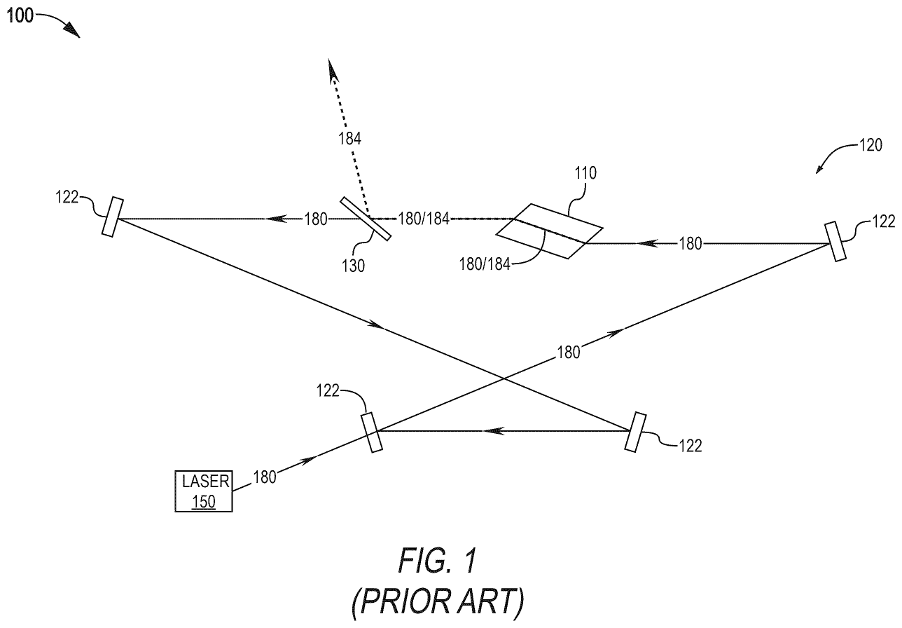

In one implementation, laser 450 generates beam 488 with a wavelength of 532 nm. For example, laser 450 may be a frequency-doubled solid-state laser with a neodymium-doped gain crystal. This implementation generates second-harmonic beam 484 with a wavelength of 266 nm. Calculations pertaining to one example of this implementation, wherein crystal 210 is a CLBO crystal, show that apparatus 400 may produce more than 5 watts of 266 nm when the intracavity power of beam 488, inside cavity 420, is about 300 watts. These calculations also show that the generated 266-nm beam has an excellent beam quality, characterized by a maximum M² factor of 1.1 due to walk-off broadening. Similar calculations pertaining to prior-art apparatus 100 of FIG. 1, show that achieving the same second-harmonic power as apparatus 400 requires twice the circulating power and therefore a significantly more powerful laser 150. Operating with twice the circulating power may or may not be feasible, in light of damage thresholds imposed by non-degenerate two-photon absorption. Several factors contribute to the superior performance of apparatus 400. One of the more significant contributing factors is that the second-harmonic generation process in apparatus 400 receives input power from two simultaneous passes through the crystal of the single laser beam circulating in the resonant-enhancement cavity. In prior-art apparatus 100, the circulating power would need to be doubled to produce the same total input power to the second-harmonic generation process, which is not possible due to the damage threshold imposed by non-degenerate two-photon absorption.

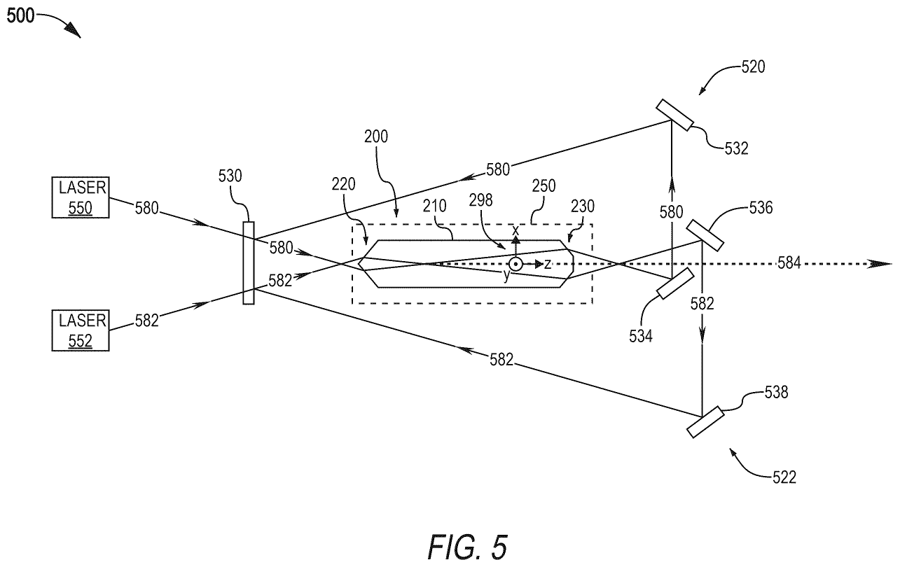

FIG. 5 illustrates one laser apparatus 500 for resonantly-enhanced, non-collinearly phase-matched sum-frequency generation in device 200, which utilizes two resonant-enhancement cavities. Apparatus includes device 200 and two lasers 550 and 552. Lasers 550 and 552 may be solid-state lasers. Lasers 550 and 552 generate respective input laser beams 580 and 582 to the sum-frequency generation process. Input beams 580 and 582 may be cw beams. Apparatus 500 further includes two resonant-enhancement cavities 520 and 522, each of which is a ring resonator. Cavity 520 resonantly enhances input beam 580, and cavity 522 resonantly enhances input beam 582. Cavities 520 and 522 are arranged such that resonantly enhanced input beams 580 and 582 intersect in crystal 210, with input beam 580 passing through input face 224 and output face 232 (see FIGS. 2A and 2B) and input beam 582 passing through input face 222 and output face 234. The propagation paths of input beams 580 and 582 through crystal 210 may be similar to those of input beams 380 and 382 of FIG. 3A-C.

In the example depicted in FIG. 5, each of cavities 520 and 522 is a triangular ring cavity. The propagation path of cavity 520 is defined by reflectors 530, 532, and 534. Reflector 530 is impedance matched to couple input beam 580 into cavity 520. Reflector 530 is optionally shared with cavity 522. The propagation path of input beam 582 in cavity 522 is further defined by reflectors 536 and 538. This depicted arrangement of cavities 520 and 522 may be replaced by other configurations of two resonant-enhancement cavities with intersecting beam paths.

Non-collinear sum-frequency mixing of resonantly-enhanced input beams 580 and 582 in crystal 210 produces a frequency-converted laser beam 584 that is not contained in either one of cavities 520 and 522. As compared to apparatus 400, the use of two resonant-enhancement cavities in apparatus 500 allows for input beams 580 and 582 to have different wavelengths. Apparatus 500 is therefore not limited to second-harmonic generation. However, apparatus 500 may be used for non-collinear second-harmonic generation when input beams 580 and 582 have the same wavelength. In such scenarios, the two lasers 550 and 552 may be replaced by a single laser, generating a single laser beam, and a beamsplitter that divides this single laser beam into input beams 580 and 582. In embodiments of apparatus 500 designed to operate with input beams 580 and 582 of different wavelengths, facets 222 and 234 may be at a different angle to the z-axis than facets 224 and 232 such that each of input beams 580 and 582 can be incident on the corresponding facets of crystal 210 at Brewster's angle.

Each of apparatuses 400 and 500 may utilize a nonlinear crystal of a different shape than crystal 210, such as a cuboidal shape, and still enable separation of the frequency-converted output beam from the input beams in non-collinear sum-frequency generation. A few select examples are discussed in the following.

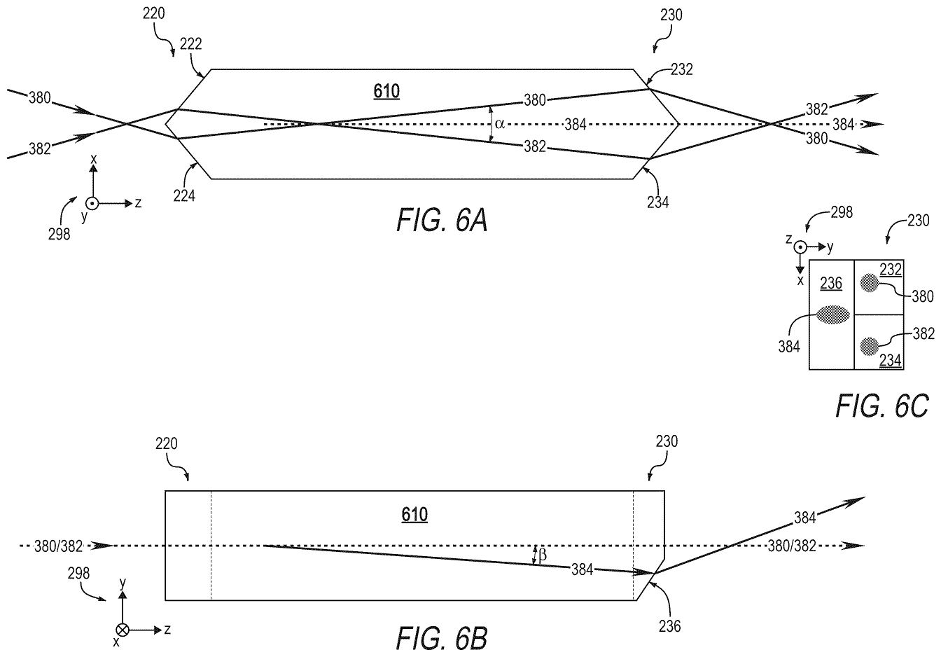

FIG. 6A-C illustrate one such nonlinear crystal 610 that enables separation of the frequency-converted output beam from the input beams in non-collinear sum-frequency generation. Crystal 610 may replace crystal 210 in either one of apparatuses 400 and 500 and can be configured to minimize Fresnel losses not only for the input laser beams but also for the frequency-converted laser beam. FIGS. 6A and 6B are orthogonal cross-sectional views of crystal 610 taken in the xz-and yz-planes, respectively. FIG. 6C depicts output end 230 of crystal 610 as viewed from outside crystal 610.

Crystal 610 is similar to crystal 210, except for a different orientation, and possibly positioning, of output face 236 for the frequency-converted laser beam. Crystal 610 accommodates a beam propagation pattern similar to that depicted in FIG. 3A-C for crystal 310. However, output face 236 for the frequency-converted laser beam, e.g., frequency-converted beam 384, is at an oblique angle to the xz-plane in crystal 610. Thus, with the same exemplary propagation paths of input beams 380 and 382 depicted also in FIG. 3A-C, frequency-converted beam 384 emerges from crystal 610 with a propagation direction that is at an oblique angle to the propagation plane of input beams 380 and 382. The orientation of output face 236 in crystal 610 may be chosen such that the frequency-converted laser beam is incident thereon at the internal Brewster's angle, thereby minimizing the Fresnel loss for the frequency-converted laser beam. In one implementation of crystal 610, input beams 380 and 382 are incident on the corresponding input and output faces at Brewster's angle, and frequency-converted beam 384 is incident on output face 236 at Brewster's angle.

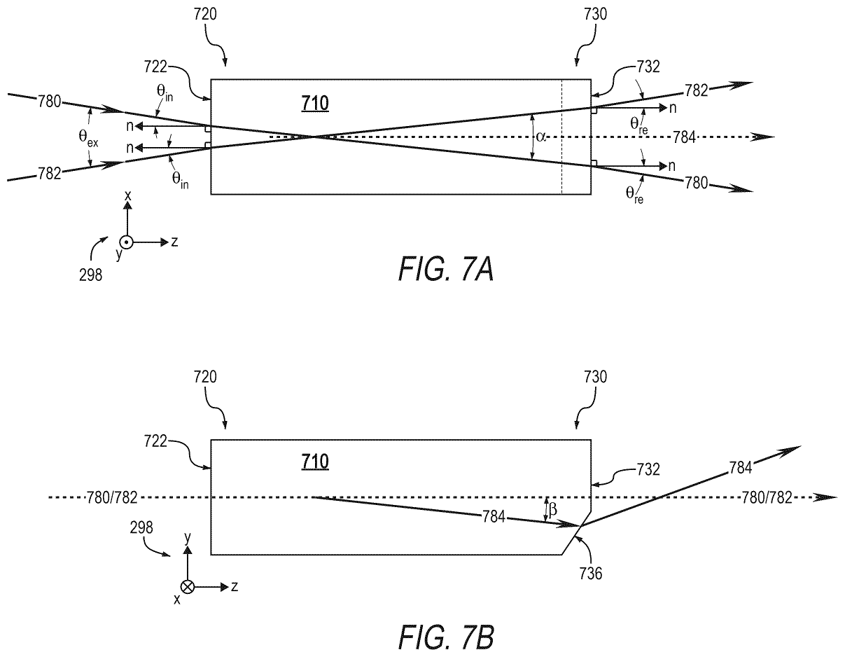

FIGS. 7A and 7B are orthogonal cross-sectional views of one nonlinear crystal 710 that is closer to cuboidal in shape and enables separation of the frequency-converted output beam from the input beams in non-collinear sum-frequency generation. Crystal 710 may replace crystal 210 in either one of apparatuses 400 and 500. FIGS. 7A and 7B also show exemplary laser beam propagation through crystal 710. Due to its simpler shape, crystal 710 may be easier to manufacture than crystals 210 and 610. An input end 720 of crystal 710 has a single planar input face 722. An output end 730 of crystal 710 has two planar output faces 732 and 736 that are non-parallel to each other. Output face 732 is parallel to input face 722.

In operation, input face 722 receives two non-collinear input laser beams 780 and 782. Non-collinear sum-frequency mixing of input beams 780 and 782 produces a frequency-converted laser beam 784. Output face 732 transmits input beams 780 and 782 out of crystal 710. The length of crystal 710 is chosen to ensure that frequency-converted beam 784 is separated from input beams 780 and 782 at output end 730. Frequency-converted laser beam 784 leaves crystal 710 via output face 736. This prevents potentially undesirable spatial overlap between frequency-converted beam 784 and input beams 780 and 782 at output end 730.

In the depicted scenario, which may be implemented in either one of apparatuses 400 and 500, input beams 780 and 782 are incident on input face 722 at the same incidence angle θᵢₙ, but on opposite sides of the normal vector to input face 722. Input beams 780 and 782 intersect inside crystal 710, and then diverge from each other. Output face 732 refracts input beams 780 and 782. The angle of refraction θᵣₑ is the same for input beams 780 and 782, but on opposite sides of the normal vector to input face 722. Beams 780, 782, and 784 have three different propagation directions after leaving crystal 710. Crystal 710 therefore provides the benefit of frequency-converted beam 784 being naturally separated from input beams 780 and 782, with no need for a dichroic optic to produce such separation, as discussed in further detail above for crystals 210 and 310.

As depicted, frequency-converted beam 784 is an extraordinary beam subject to walk-off in crystal 710, while input beams 780 and 782 are ordinary beams. Any one or two of beams 780, 782, and 784 may be extraordinary beams subject to walk-off, while the non-collinear relationship between input beams 780 and 782 ensures separation of frequency-converted beam 784 from input beams 780 and 782.

Advantageously, output face 736 may be oriented such that frequency-converted beam 784 is incident thereon at internal Brewster's angle. In contrast, in most scenarios, input beams 780 and 782 will not be incident on either one of input face 722 and output face 732 at Brewster's angle. The relatively large external angle θᵣₑ between input beams 780 and 782 required for incidence at Brewster's angle will produce a relatively large angle α between input beams 780 and 782 inside crystal 710. A large angle α between input beams 780 and 782 inside crystal 710 leads to a short interaction length between input beams 780 and 782 and therefore a low frequency-conversion efficiency. Crystal 710 represents a compromise between the simplicity of the crystal shape and the benefits of operation with the input beams are incident on crystal surfaces at Brewster's angle.

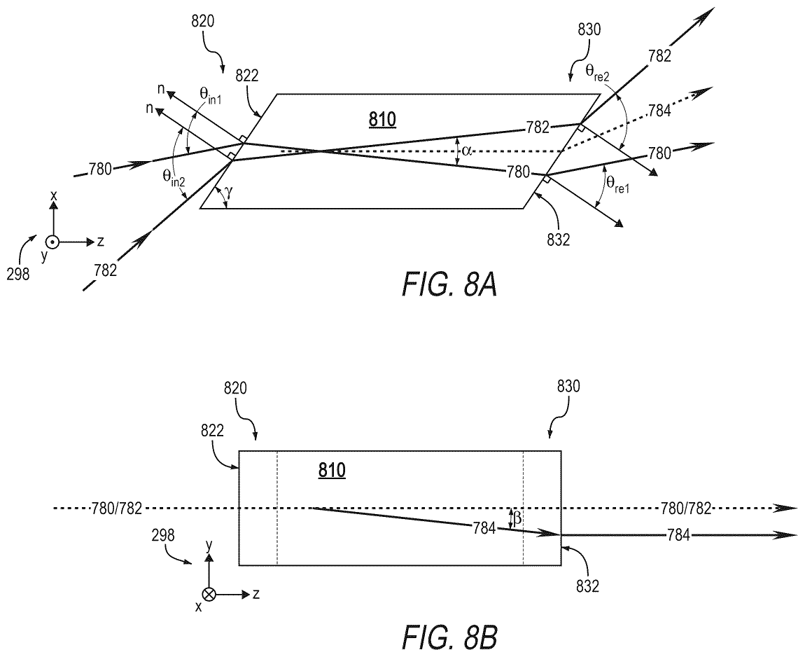

FIGS. 8A and 8B are orthogonal cross-sectional views of one nonlinear crystal 810 that is shaped as a right parallelogrammic prism and enables separation of the frequency-converted output beam from the input beams in non-collinear sum-frequency generation. Crystal 810 may replace crystal 210 in either one of apparatuses 400 and 500. FIGS. 8A and 8B also show exemplary laser beam propagation through crystal 810. An input end 820 of crystal 810 has a planar input face 822 configured to receive both of input beams 780 and 782. A planar output face 832 at an output end 830 of crystal 810 is parallel to input face 822 and is configured to transmit input beams 780 and 782 as well as frequency-converted beam 784.

As compared to crystal 710, input beams 780 and 782 are incident on input face 822 on the same side of the normal vector thereto, but at different angles of incidence θᵢₙ₁ and θᵢₙ₂. In one implementation, that may be realized in either one of apparatuses 400 and 500, angle γ (defining the parallelogrammic shape) may be sized such that angles of incidence θᵢₙ₁ and θᵢₙ₂ are equally displaced from Brewster's angle. In this implementation, the respective angles of refraction θᵣₑ₁ and θᵣₑ₂ of input beams 780 and 782 are on the same side of the normal vector to output face 832 but differ in size. Advantageously, this implementation allows for both of input beams 780 and 782 to be incident on input face 822 and output face 832 near (but not exactly at) Brewster's angle.

Beams 780, 782, and 784 emerge from crystal 810 with different propagation directions, thus eliminating the need for a dichroic optic to separate frequency-converted beam 784 from input beams 780 and 782. Additionally, the length of crystal 810 is preferably sufficient that frequency-converted beam 784 is separate from input beams 780 and 782 at output face 832, so as to prevent potentially undesirable spatial overlap between frequency-converted beam 784 and either one of input beams 780 and 782 on this face. The depicted beam propagation assumes that input beams 780 and 782 are ordinary beams and frequency-converted beam 784 is an extraordinary beam subject to walk-off. However, the advantageous separation between frequency-converted beam 784 and either one of input beams 780 and 782, both at output face 832 and further away from crystal 810, is achievable regardless of which of beams 780, 782, and 784 are subject to walk-off.

Without departing from the scope hereof, output end 830 of crystal 810 may be modified to have a dedicated output face for frequency-converted beam 784, similar to output face 736 of crystal 710. Such a dedicated output face may be oriented to allow frequency-converted beam 784 to be incident thereon at Brewster's angle.

The material composition of each of crystals 610, 710, and 810 may be similar to that of crystal 210, and crystals 610, 710, and 810 are applicable to the same wavelengths of input and frequency-converted laser beams as discussed for crystal 210. When implemented in either one of apparatus 400 or 500, crystal 810 may be oriented such that the input and output faces thereof are orthogonal to the propagation plane of laser beams involved in the sum-frequency generation process. This allows for translation of the crystal orthogonally to the common plane without disturbing the propagation paths of the involved laser beams, which may be useful if the crystal is subject to optical degradation.

When crystal 710 or 810 is implemented in apparatus 400, cavity 420 may be configured such that input beams 480 and 482 pass through crystal 710/810 in the same manner as discussed for input beams 780 and 782 in reference to FIGS. 7A-8B. When crystal 710 or 810 is implemented in apparatus 500, cavities 520 and 522 may be configured such that input beams 580 and 582 pass through crystal 710/810 in the same manner as discussed for input beams 780 and 782 in reference to FIGS. 7A-8B.

The present invention is described above in terms of a preferred embodiment and other embodiments. The invention is not limited, however, to the embodiments described and depicted herein. Rather, the invention is limited only by the claims appended hereto.

What is claimed is:

1. A device for non-collinear sum-frequency generation, comprising:
an optically-nonlinear crystal having:
an input end including first and second input faces that are planar and mutually non-parallel, and
an output end opposite the input end and including (a) first and second output faces that are planar and mutually non-parallel and (b) a third output face that is non-parallel to each of the first and second output faces;
wherein respective normal vectors of the first and second input faces point away from the crystal in mutually-diverging directions, and respective normal vectors of the first and second output faces point away from the crystal in mutually-diverging directions.

2. The device of claim 1, wherein the first input face is parallel to the first output face, and the second input face is parallel to the second output face.

3. The device of claim 1, wherein the first and second input faces and the first and second output faces are orthogonal to and intersect a first plane.

4. The device of claim 3, wherein:
the first and second input faces are on first and second sides, respectively, of a second plane that is orthogonal to the first plane and that intersects the input and output ends,
the first output face is on the second side of the second plane, and
the second output face is on the first side of the second plane.

5. The device of claim 3, wherein the third output face is orthogonal to the first plane and disposed between the first and second output faces.

6. The device of claim 3, wherein the third output face is displaced from the first plane and is oriented at an oblique angle to the first plane.

7. A laser apparatus for sum-frequency generation, comprising:
the device of claim 1; and
at least one laser source to generate first and second input laser beams;
wherein:
the first and second input faces are positioned to receive the first and second input laser beams, respectively,
the first output face is positioned to transmit the first input laser beam after passing through the crystal along a first path from the first input face,
the second output face is positioned to transmit the second input laser beam after passing through the crystal along a second path from the second input face, the second path intersecting the first path non-collinearly,
the third output face is positioned to transmit a frequency-converted laser beam generated from the first and second input laser beams through non-collinear sum-frequency generation.

8. The laser apparatus of claim 7, wherein the first and second input faces and the first and second output faces are oriented such that the first and second input laser beams are incident thereon at Brewster's angle.

9. The laser apparatus of claim 7, wherein:
the at least one laser source consists of a single laser source to generate an initial laser beam,
the laser apparatus further comprising a resonant-enhancement cavity containing the crystal and arranged to (a) resonantly enhance the initial laser beam and (b) direct the initial laser beam along a closed path including first and second segments non-collinearly intersecting each other in the crystal,
the first input face and the first output face intersect the first segment,
the second input face and the second output face intersect the second segment, and
the initial laser beam, as resonantly enhanced, forms (a) the first input laser beam when passing through the crystal along the first segment and (b) the second input laser beam when passing through the crystal along second segment.

10. The laser apparatus of claim 7, further comprising first and second resonant-enhancement cavities to resonantly enhance the first and second input laser beams, respectively, wherein:
respective beam paths of the first and second resonant-enhancement cavities intersect non-collinearly in the crystal,
the beam path of the first resonant-enhancement cavity passes through the first input face and the first output face, and
the beam path of the second resonant-enhancement cavity passes through the second input face and the second output face.

11. A laser apparatus for resonantly enhanced non-collinear second-harmonic generation, comprising:
a laser source to generate an initial laser beam; and
a resonant-enhancement cavity containing an optically-nonlinear crystal and arranged to receive the initial laser beam so as to resonantly enhance the initial laser beam, the resonant-enhancement cavity being a ring resonator configured to direct the initial laser beam along a closed path including non-collinearly intersecting first and second segments intersecting in the crystal, so as to generate a second-harmonic laser beam from non-collinear sum-frequency mixing of (a) a first input laser beam formed by the initial laser beam when passing through the crystal along the first segment and (b) a second input laser beam formed by the initial laser beam when passing through the crystal along the second segment.

12. The laser apparatus of claim 11, wherein the ring resonator is a bowtie resonator.

13. The laser apparatus of claim 11, wherein propagation of the initial laser beam inside the crystal takes place in a first plane, and the second-harmonic laser beam propagates at an oblique angle to the first plane inside the crystal.

14. The laser apparatus of claim 13, wherein each face of the crystal intersected by the first and second input laser beams is orthogonal to the first plane.

15. The laser apparatus of claim 11, wherein each of the first and second input laser beams is incident on and exits the crystal at Brewster's angle.

16. The laser apparatus of claim 11, wherein the crystal includes:
an input end including planar and mutually-nonparallel first and second input faces respectively intersecting the first and second segments to receive the first and second input laser beams; and
an output end including (a) planar and mutually-nonparallel first and second output faces respectively intersecting the first and second segments to transmit the first and second input laser beams after passing through the crystal and (b) a third output face to emit the second-harmonic laser beam, the third output face being non-parallel to each of the first and second output faces;
wherein the first input laser beam intersects the first input and output faces at Brewster's angle, and the second input laser beam intersects the second input and output faces at Brewster's angle.

17. The laser apparatus of claim 11, wherein the crystal includes:
a planar input face intersecting the first and second segments to receive the first and second input laser beams; and
a planar output face parallel to the planar input face and intersecting the first and second segments to (a) transmit the second harmonic laser beam and (b) transmit the first and second input laser beams after passing through the crystal from the planar input face.

18. The laser apparatus of claim 17, wherein:
the first and second input laser beams are incident on the planar input face at respective first and second angles of incidence with respect to a normal vector of the planar input face, the first and second angles of incidence being on the same side of the normal vector of the planar input face; and
the two first and second input laser beams propagate away from the planar output face at respective first and second angles of refraction with respect to a normal vector of the planar output face, the first and second angles of refraction being on the same side of the normal vector of the planar output face.

19. The laser apparatus of claim 11, wherein the crystal includes:
a planar input face intersecting the first and second segments to receive the first and second input laser beams;
a planar fundamental-output face intersecting the first and second segments to transmit the first and second input laser beams after passing through the crystal, the first planar output face being parallel to the planar input face; and
a planar second-harmonic-output face to transmit the second harmonic laser beam, the planar second-harmonic-output face being at an oblique angle to the planar input face;
wherein propagation of the first and second input laser beams inside the crystal takes place in a first plane, and the second-harmonic-output face is displaced from the first plane.

20. The laser apparatus of claim 11, wherein a phase difference between the first and second input laser beams in the crystal is adjustable.
